(19) United States
(12) Patent Application Publication
(10) Pub. No.: US 2005/0156427 A1
(43) Pub. Date: Jul. 21, 2005

(54) Advertising display assembly having a hinged support

(76) Inventors: Scott D. Best, Troy, MI (US); James F. Turner, Farmington Hills, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/033,652

(22) Filed: Jan. 12, 2005

Related U.S. Application Data
(60) Provisional application No. 60/535,776, filed on Jan. 12, 2004.

(51) Int. Cl. G09F 1/00

(52) U.S. Cl. 283/56

(57) ABSTRACT

The subject invention provides an advertising display assembly (10) including two layers of stock material (12, 28) defining a plurality of outer peripheral edges (42, 44, 46). A release liner (24) is sandwiched therebetween. A plurality of score lines (62) define an integral coupon card (20) within the assembly (10) and an outer strip of material (22) between the integral card (20) and the outer peripheral edges (42, 44, 46). A plurality of mini-coupons (58) are detachably cut into the integral card (20) through the second layer of stock material (28). The assembly (10) is characterized by a hinge (74) extending across the strip of material (22) and defining an upper portion (76) and a lower portion (78) in the strip of material (22). The lower portion (78) of the strip of material (22) rotates relative to the upper portion (76) and the integral card (20) for supporting the assembly (10) on a surface (80) in an upright position for display.

### CROSS REFERENCE TO RELATED APPLICATION

This application claims priority to and the benefits of U.S. Provisional Patent Application Ser. No. 60/535,776, filed on Jan. 12, 2004.

### BACKGROUND OF THE INVENTION

1. Field of the Invention

The subject invention relates to a coupon card, and more specifically to a coupon card disposed within an advertising display assembly that is supportable on a surface.

2. Description of the Prior Art

Coupon cards having a number of mini-coupons that may be removed and redeemed are well known. It is also well known to place an individual mini-coupon directly on a product for instant redemption. The mini-coupons are a popular means of attracting customers and encouraging additional sales. The prior art coupon cards and mini-coupons have various constructions and are used for a multitude of applications. An example of a prior art coupon card with mini-coupons is disclosed in U.S. Pat. No. 5,417,458. The '458 patent is assigned to the assignee of the subject invention and includes a novel structure of two layers of card stock sandwiching a liner with an adhesive layer disposed between each layer of card stock and the liner. The two layers of card stock allow the mini-coupons to be removed while maintaining sufficient integrity and rigidity within the card itself.

U.S. Pat. No. 6,092,841 discloses a promotional one-piece mailer. The '841 patent is assigned to the assignee of the subject invention and includes a coupon card within the promotional mailer. The promotional mailer is constructed as described in the '458 patent. The promotional mailer includes a plurality of outer peripheral edges, and a plurality of score lines spaced from the plurality of outer peripheral edges to completely define the coupon card. The plurality of peripheral edges and the plurality of score lines define a strip of material therebetween. The promotional mailer includes printed matter on an outer surface of both the first layer of card stock and the second layer of card stock. A laminate layer is preferably adhered to the outer surfaces of the first layer of card stock and the second layer of card stock over the printed matter.

U.S. Pat. No. 5,332,265 discloses an advertising assembly for display in an upright position on a surface. The advertising assembly includes a layer of card stock and a layer of flexible polymeric material adhered to the layer of card stock by an adhesive. A plurality of detachable mini-coupons are cut into the layer of flexible polymeric material. The layer of card stock includes a fold line extending across the advertising assembly and defining a first half and a second half with the plurality of mini-coupons disposed on both sides. The advertising assembly may be folded about the fold line for supporting the assembly on a surface in an upright position. However, the advertising assembly does not include any space on the assembly for advertisements other than those printed on the detachable mini-coupons. The fold line also creates a line of weakness across the advertising assembly, which is undesirable for a customer storing the advertising assembly between uses.

### SUMMARY OF THE INVENTION AND ADVANTAGES

The subject invention provides an advertising display assembly that is supportable on a surface. The assembly includes a layer of stock material having a plurality of outer peripheral edges. An integral card is disposed within the assembly and spaced from the outer peripheral edges. A plurality of score lines are cut through the layer of stock material and are spaced from the outer peripheral edges to define the card integrally disposed within the assembly and a strip of material disposed between the plurality of outer peripheral edges and at least a portion of the integral card. The invention is characterized by a hinge extending across the strip of material to define an upper portion and a lower portion of the strip of material. The lower portion is rotatable relative to the upper portion and relative to the integral card for supporting the assembly on the surface in an upright position relative to the surface.

Accordingly, the subject invention provides an advertising display assembly that is positionable in an upright position on a surface and allows additional advertising to be printed on the strip of material, separate from any printed matter on the integral card. Additionally, the assembly includes a card that is removable from the display assembly and the card does not include a line a weakness, thereby increasing the strength and rigidity of the integral card.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of an advertising display assembly configured to stand upright on a surface;

FIG. 2 is a fragmentary cross-sectional view of the advertising display assembly cut along cut line 2-2 of FIG. 5;

FIG. 3 is an exploded view of FIG. 2;

FIG. 4 is a side view of the assembly standing upright on the surface;

FIG. 5 is a Planar front view of the assembly;

FIG. 6 is a Planar back view of the assembly illustrating a plurality of detachable mini-coupons;

FIG. 7 is a perspective view of the assembly with a coupon card detachably spaced therefrom; and

FIG. 8 is a perspective view of an alternative embodiment of the advertising display assembly configured to stand upright on the surface.

### DETAILED DESCRIPTION OF THE PREFERRED EMBODIMENT

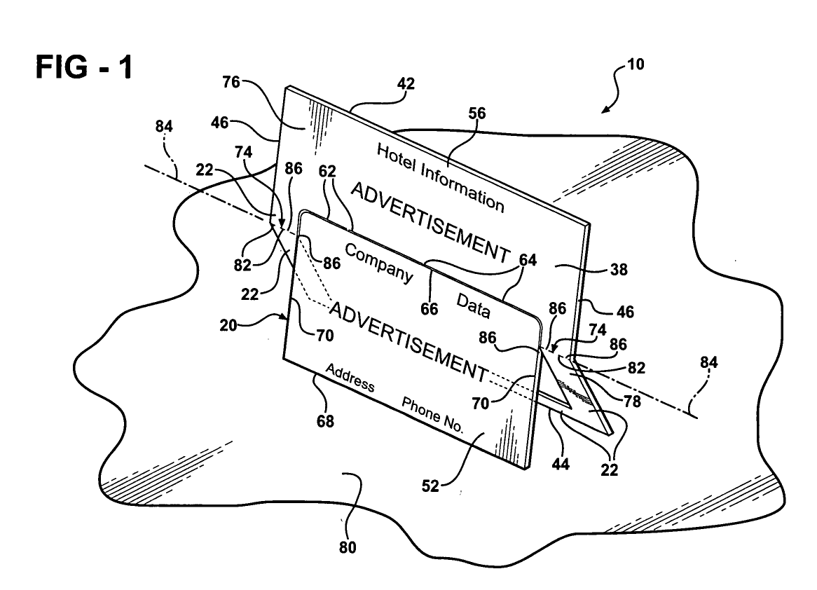

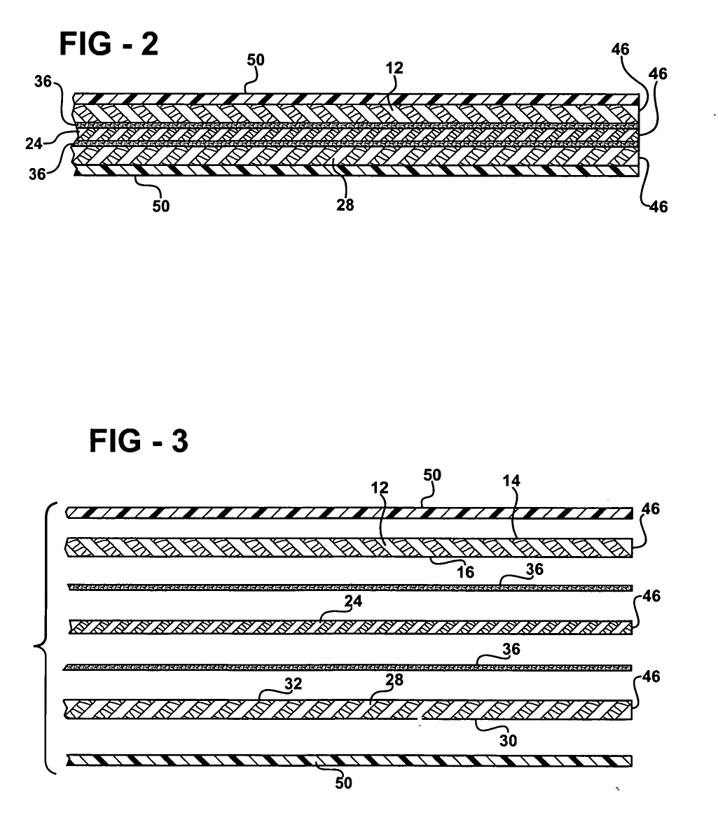

Referring to the Figures, wherein like numerals indicate like or corresponding parts throughout the several views, an advertising display assembly is generally shown at 10 in FIG. 1. Referring also to FIGS. 2 and 3, the preferred structure of the advertising display assembly 10 includes a first layer of stock material 12 having an exterior surface 14 and an interior surface 16 with a plurality of outer peripheral edges 42, 44, 46. An integral coupon card 20 is disposed within the assembly 10 and is spaced from the outer peripheral edges 42, 44, 46 to define a strip of material 22 disposed between the outer peripheral edges 42, 44, 46 and the integral card 20. A liner 24 having opposing surfaces is adhered to the interior surface 16 of the first layer of stock material 12. The liner 24 includes a plurality of outer peripheral edges 42, 44, 46 aligned with the plurality of outer peripheral edges 42, 44, 46 of the first layer of stock material 12.

The display assembly 10 also preferably includes a second layer of stock material 28 having an exterior surface 30 and an interior surface 32 and a plurality of outer peripheral edges 42, 44, 46 aligned with the plurality of outer peripheral edges 42, 44, 46 of the first layer of stock material 12. The interior surface 32 of the second layer of stock material 28 is adhered to the liner 24 to sandwich the liner 24 between the first 12 and second 28 layers of stock material. An adhesive layer 36 is disposed between each of the interior surfaces 16, 32 of the first 12 and second 28 layers of stock material and the opposing surfaces of the liner 24 to adhere the first 12 and second 28 layers of stock material to the liner 24. In addition, a release coating (not illustrated) is disposed on one side of the liner 24, preferably between the liner 24 and the second layer of stock material 28.

The completed structure of the assembly 10 preferably has the exterior surface 14 of the first layer of stock material 12 defining a front side 38 of the assembly 10 and the exterior surface 30 of the second layer of stock material 28 defining a back side 40 of the assembly 10. As appreciated, the printing as shown in the Figures on the front 38 and back 40 sides of the assembly 10 is provided for illustrative purposes only. As is also appreciated, the display assembly 10 may be formed of only a single layer of stock material without deviating from the scope of the subject invention.

The first 12 and second 28 layers of stock material are preferably manufactured form a paper card stock. However, it should be appreciated that other materials may be used for the first 12 and second 28 layers of stock material without limiting the scope of the subject invention.

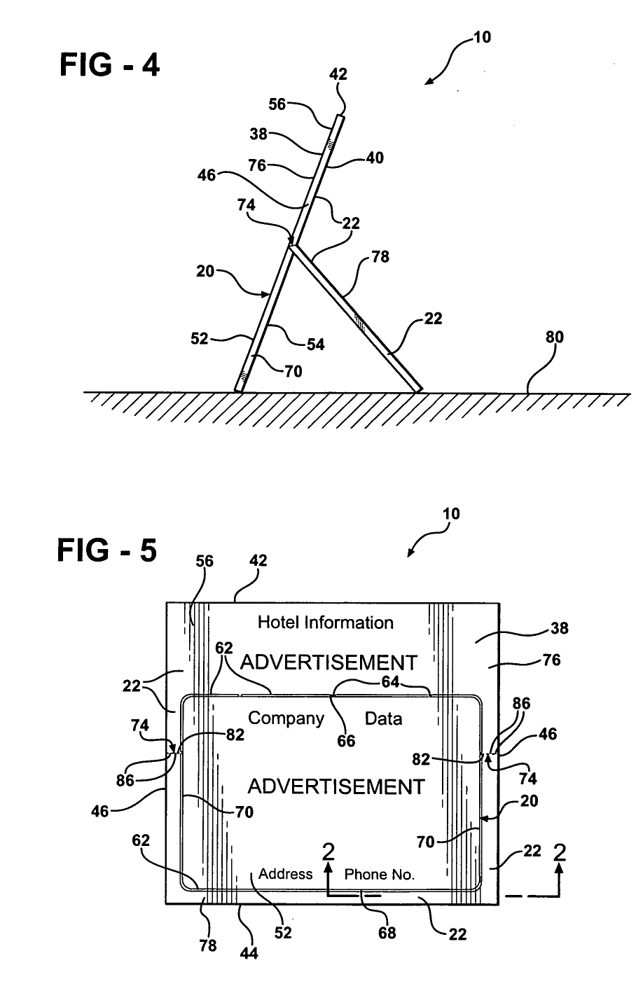

Referring also to FIGS. 4 through 7, the plurality of outer peripheral edges 42, 44, 46 of the first 12 and second 28 layers of stock material and the liner 24 include a top peripheral edge 42, a bottom peripheral edge 44, and two side peripheral edges 46. In the preferred embodiment, the top peripheral edge 42 is parallel to the bottom peripheral edge 44. The side peripheral edges 46 are parallel to each other and perpendicular to the top peripheral edge 42 to define a rectangular assembly 10.

Printed matter (indicia) is imprinted on each of the exterior surfaces 14, 30 of the first 12 and second 28 layers of stock material. Hence, the front 38 and back 40 sides of the assembly 10 are distinguished by the messages conveyed by the printed matter. To protect the printed matter, a laminate 50 can be adhered to each of the exterior surfaces 14, 30 of the first 12 and second 28 layers of stock material over the printed matter.

The integral card 20 is formed within the first 12 and second 28 layers of stock material and the liner 24. As appreciated, the integral card 20 has a front side 52 and a back side 54, which correlate to the front side 38 and back side 40 of the assembly 10. As also appreciated, the integral card 20 has an identical construction as the assembly 10 itself, as discussed above. Further, the integral card 20 has printed matter on both the front side 52 and the back side 54 of the integral card 20. Preferably, the integral card 20 is positioned closer to the bottom peripheral edge 44 of the assembly 10 relative to the top peripheral edge 42 to offset the integral card 20 within the assembly 10 and provide an enlarged advertisement portion 56 on the assembly 10 above the integral card 20. The advertisement portion 56 is preferably large enough to provide adequate space for whatever advertisements or promotional information is desired that relates to the integral card 20.

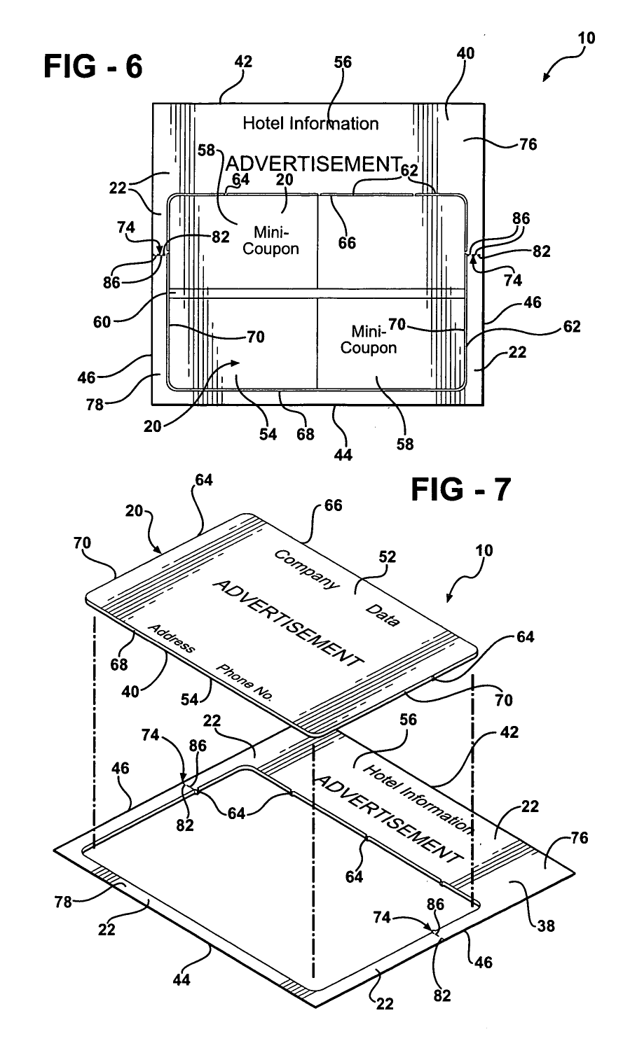

Referring to FIG. 6, the integral card 20 is preferably a coupon card having a plurality of mini-coupons 58 detachably cut into the integral card 20 through the second layer of stock material 28, i.e., the back side 40, 54 of the assembly 10 and integral card 20 respectively. The mini-coupons 58 are imprinted to convey any number of suitable coupon type messages as is desired. As an example, FIG. 6 shows two parallel rows of two mini-coupons 58 each. As appreciated, any number of mini-coupons 58 may be positioned in any particular fashion within the integral card 20. The integral card 20 further includes an information area 60 positioned adjacent the mini-coupons 58 for conveying selected information to a customer. As illustrated, the information area 60 is positioned lengthwise between the two rows of mini-coupons 58. As also appreciated, the information area 60 may be positioned to one side of the mini-coupons 58 or crossway of the mini-coupons 58.

The assembly 10 includes a plurality of score lines 62 cut through the first 12 and second 28 layers of stock material and the liner 24, and spaced from the outer peripheral edges 42, 44, 46 of the first 12 and second 28 layers of stock material and the liner 24 to completely define the integral card 20 disposed within the assembly 10. Hence, in the preferred embodiment, the integral card 20 is completely disposed within the assembly 10 such that the plurality of score lines 62 do not intersect the plurality of outer peripheral edges 42, 44, 46 of the assembly 10. As such, the strip of material 22 completely surrounds the integral card 20 and encapsulates the integral card 20 within the assembly 10. This increases the structural integrity of the assembly 10. It should be appreciated, however, that the integral card 20 does not have to be completely surrounded by the strip of material 22 and the encapsulation of the integral card 20 within the assembly 10 does not limit the overall scope of the invention.

The first 12 and second 28 layers of stock material and the liner 24 further include a plurality of connection points 64 disposed between each of the plurality of score lines 62 to interconnect the integral card 20 to at least a portion of the strip of material 22. The plurality of connection points 64 alternate between the plurality of score lines 62 and securely maintain the integral card 20 within the assembly 10. The connection points 64 are best shown in FIGS. 5 through 7 and are areas of the first 12 and second 28 layers of stock material and the liner 24, which were not cut or scored, such that the integral card 20 is removably attached to the assembly 10. To remove the integral card 20, a user pushes on the integral card 20 until the plurality of connection points 64 are broken, which completely severs the integral card 20 from the assembly 10 (see FIG. 7). If the integral card 20 includes the plurality of mini-coupons 58 as discussed above, the integral card 20 can then be utilized, i.e., the mini-coupons 58 can be peeled off and redeemed. The release coating (not illustrated) on the liner 24 allows the mini-coupons 58 to be removed from the liner 24 without damaging the remaining portions of the integral card 20. Preferably, a portion of the second layer of stock material 28 and the associated adhesive 36 defines each of the removed mini-coupons 58.

After the integral card 20 is punched out, the remaining portion of the assembly 10 will typically be discarded. The integral card 20, therefore, preferably has printed matter on both the front 52 and back 54 sides of the integral card 20 so that the user can associate the integral card 20 with a particular vendor. As appreciated, logos, promotional messages, company addresses and other like information will be imprinted on the front side 52 of the integral card 20 and the mini-coupons 58, with the discount information, will be imprinted and scored on the back side 54 of the integral card 20.

The integral card 20 includes a top card edge 66, a bottom card edge 68, and two side card edges 70. Preferably, the top card edge 66 is parallel to the bottom card edge 68. The side card edges 70 are parallel each other and perpendicular to the top card edge 66 to define a rectangular shape. The top card edge 66 and the bottom card edge 68 each have a length of three and three eights inches (3⅜″), and the side card edges 70 each have a length of two and one eighth inches (2⅛″) to define the rectangular integral card 20. These dimensions substantially match those of a standard credit card. As appreciated, the overall scope of the subject invention is in no way limited to the specific size of the integral card 20.

During the manufacture of the assembly 10, the assembly 10 is preferably formed and then the integral card 20 is punched out of the assembly 10. Even more preferably, the assembly 10 is manufactured by a manufacturing machine of the type disclosed in U.S. Pat. Nos. 5,776,287 and 6,315,023; each of which is assigned to the assignee of the subject invention and the disclosure of each is herein incorporated by reference.

The assembly 10 is characterized by a hinge 74 extending across the strip of material 22 to define an upper portion 76 and a lower portion 78 of the strip of material 22 for rotating the lower portion 78 relative to the upper portion 76 and relative to the integral card 20. The lower portion 78 of the strip of material 22 rotates to support the assembly 10 on a surface 80 in an upright position relative to the surface 80.

The hinge 74 includes a plurality of perforations 82 extending across the strip of material 22. In the preferred embodiment, the plurality of perforations 82 are cut through the first 12 and second 28 layers of stock material and the liner 24 of the strip of material 28. Alternatively, the perforations 82 could only be cut through one of the layers of stock material 12, 28. Further, the perforations 82 could only be cut through one of the layers of stock material 12, 28 and the liner 24. The plurality of perforations 82 define a plurality of hinge connectors 86 between the upper portion 76 and the lower portion 78 of the strip of material 22 for interconnecting the upper 76 and lower 78 portions. The plurality of perforations 82 and the plurality of hinge connectors 86 define a fold line 84 about which the lower portion 78 of the strip of material 22 rotates.

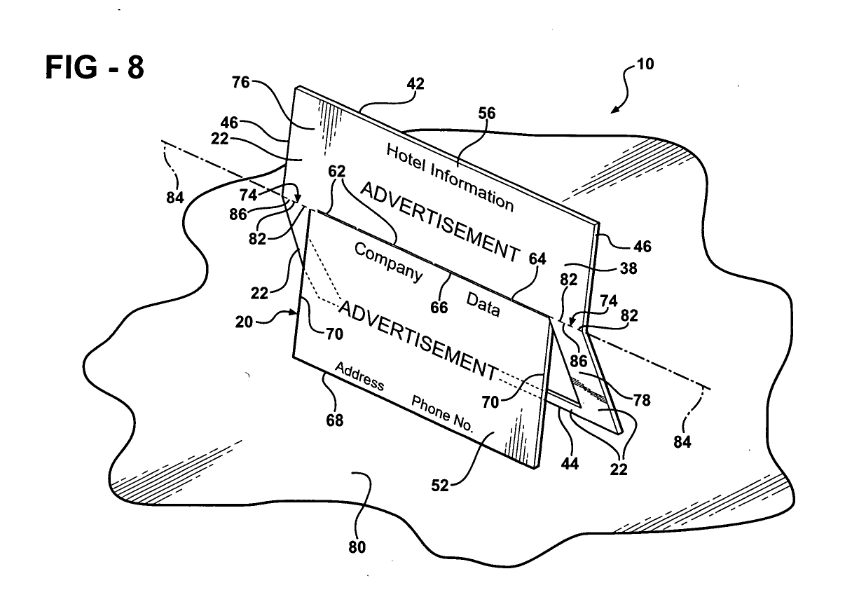

The hinge 74 is preferably disposed along the side card edges 70 between the top card edge 66 and the bottom card edge 68. More preferable, the hinge 74 is located from the top card edge 66 approximately one quarter the distance between the top card edge 66 and the bottom card edge 68. Alternatively, as shown in FIG. 8, the hinge 74 may be located at the intersection of the top card edge 66 and the side card edges 70. As appreciated, the exact location of the hinge 74 in no way limits the scope of the invention.

Preferably, the integral card 20 is completely separated from the strip of material 22 along the bottom card edge 68 and the side card edges 70 between the hinge 74 and the bottom card edge 68. The separation of the integral card 20 from the strip of material 22 along these sections allows the lower portion 78 of the strip of material 22 to easily rotate relative to the integral card 20 and the upper portion 76 of the strip of material 22, without having to detach any of the connection points 64 prior to rotation. As appreciated, the subject invention is not limited by the lack of connection points 64 along these sections, and if included, must simply be detached prior to rotation.

Obviously, many modifications and variations of the present invention are possible in light of the above teachings. The invention may be practiced otherwise than as specifically described within the scope of the appended claims, wherein that which is prior art is antecedent to the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the incentive novelty exercises its utility. In addition, the reference numerals in the claims are merely for convenience and are not to be read in any way as limiting.

1. A advertising display assembly (10) supportable on a surface (80), said assembly (10) comprising:
a layer of stock material (12) having a plurality of outer peripheral edges (42, 44, 46);
an integral card (20) disposed within said assembly (10) and spaced from said outer peripheral edges (42, 44, 46);
a plurality of score lines (62) cut through said layer of stock material (12) and spaced from said outer peripheral edges (42, 44, 46) to define said card (20) integrally disposed within said assembly (10) and define a strip of material (22) disposed between said plurality of outer peripheral edges (42, 44, 46) and at least a portion of said integral card (20);
said assembly (10) characterized by a hinge (74) extending across said strip of material (22) to define an upper portion (76) and a lower portion (78) of said strip of material (22) with said lower portion (78) rotatable relative to said upper portion (76) and relative to said integral card (20) for supporting said assembly (10) on the surface (80) in an upright position relative to the surface (80).

2. An assembly (10) as set forth in claim 1 wherein said hinge (74) includes a plurality of perforations (82) cut through said strip of material (22) to define at least one hinge connector (86) between said upper portion (76) and said lower portion (78) for interconnecting said upper portion (76) and said lower portion (78) and to define a fold line (84) about which said lower portion (78) rotates.

3. An assembly (10) as set forth in claim 1 further including a plurality of connection points (64) in said layer of stock material (12) alternating between said plurality of score lines (62) for interconnecting said integral card (20) to at least a portion of said strip of material (22).

4. An assembly (10) as set forth in claim 1 wherein said layer of stock material (12) is further defined as a first layer of stock material (12) and a second layer of stock material (28) with each of said first (12) and second (28) layers of stock material having exterior (14, 30) and interior (16, 32) surfaces.

5. An assembly (10) as set forth in claim 4 further including a liner (24) having opposing surfaces and a plurality of outer peripheral edges (42, 44, 46) aligned with said outer peripheral edges (42, 44, 46) of said first (12) and second (28) layers of stock material with said interior surfaces (16, 32) of said first (12) and second (28) layers of stock material adhered to said opposing surfaces of said liner (24) to sandwich said liner (24) there between.

6. An assembly (10) as set forth in claim 5 wherein said plurality of score lines (62) extend through said first (12) and second (28) layers of stock material and said liner (24) to completely define said integral card (20).

7. An assembly (10) as set forth in claim 6 further including a plurality of mini-coupons (58) detachably cut into said integral card (20) through said second layer of stock material (28).

8. An assembly (10) as set forth in claim 7 further including an adhesive layer (36) between said interior surfaces (16, 32) of said first (12) and second (28) layers of stock material and said liner (24) for adhering said first (12) and second (28) layers of stock material to said liner (24).

9. An assembly (10) as set forth in claim 8 further including printed indicia on said exterior surfaces (14, 30) of said first (12) and second (28) layers of stock material.

10. An assembly (10) as set forth in claim 9 further including a laminate layer (50) adhered to said exterior surfaces (14, 30) of said first (12) and second (28) layers of stock material over said printed indicia.

11. An assembly (10) as set forth in claim 1 wherein said integral card (20) includes a top card edge (66), a bottom card edge (68), and side card edges (70).

12. An assembly (10) as set forth in claim 11 wherein said integral card (20) is completely separated from said outer strip of material (22) along said bottom card edge (68) and said side card edges (70) between said hinge (74) and said bottom card edge (68).

13. An assembly (10) as set forth in claim 12 wherein said hinge (74) is disposed along said side card edges (70) between said top card edge (66) and said bottom card edge (68).

14. An assembly (10) as set forth in claim 12 wherein said hinge (74) is disposed along said top card edge (66).

15. An assembly (10) as set forth in claim 1 wherein said outer peripheral edges (42, 44, 46) of said first (12) and second (28) layers of stock material and said liner (24) include a top peripheral edge (42), a bottom peripheral edge (44), and two side peripheral edges (46) with said top peripheral edge (42) parallel to said bottom peripheral edge (44) and said side peripheral edges (46) parallel to each other and perpendicular to said top peripheral edge (42) to define said assembly (10) such that said strip of material (22) surrounds said integral card (20) and encapsulates said integral card (20) within said assembly (10).

16. An assembly (10) as set forth in claim 15 wherein said integral card (20) is positioned closer to said bottom peripheral edge (44) relative to said top peripheral edge (42) to off-set said integral card (20) within said assembly (10) and provide an enlarged advertisement portion (56) in said outer strip of material (22).

17. An assembly (10) as set forth in claim 16 wherein a top card edge (66) of said integral card (20) is parallel to a bottom card edge (68) and side card edges (70) of said integral card (20) are parallel to each other and perpendicular to said top card edge (66) to define said integral card (20) encapsulated by said peripheral edges (42, 44, 46) of said strip of material (22).
